(19) United States
(12) Patent Application Publication
(10) Pub. No.: US 2026/0163049 A1
(43) Pub. Date: Jun. 11, 2026

(54) BATTEY MANUFACTURING APPARATUS AND MANUFACTURING METHOD OF THE SAME

(71) Applicant: SK On Co., Ltd., Seoul (KR)

(72) Inventors: Ho Jun LEE, Daejeon (KR); Byeong Chan KIM, Daejeon (KR); Hyun Seong CHOI, Daejeon (KR); Jung Uk KIM, Daejeon (KR)

(21) Appl. No.: 19/414,282

(22) Filed: Dec. 10, 2025

(30) Foreign Application Priority Data
Dec. 11, 2024 (KR) 10-2024-0183423

(51) Int. Cl. H01M 10/04; H01M 50/105

(52) U.S. Cl. CPC H01M 10/0481; H01M 50/105

(57) ABSTRACT

The present disclosure relates to a method for manufacturing a battery cell, including an electrode assembly; an electrolyte in which the electrode assembly is immersed; a case including a first receiving space accommodating the electrode assembly and the electrolyte; and a second receiving space spaced apart from the first receiving space and communicating with the first receiving space, using a battery cell manufacturing apparatus, the method may comprise: pressing at least a portion of the first receiving space using a pressing member that moves to contact at least a portion of the first receiving space; fixing at least a portion of the case using a fixing member that moves to contact at least a portion of the periphery of the case; and punching a through hole penetrating the case corresponding to a portion of the second receiving space using a punching member that moves toward the second receiving space.

### CROSS-REFERENCE TO RELATED PATENT APPLICATION

The present application claims priority under 35 U.S.C. § 119a to Korean patent applications number 10-2024-0183423 filed on December 11, 2024 in the Ministry of Intellectual Property, the entire disclosures of which are incorporated by reference herein.

### BACKGROUND OF THE DISCLOSURE

### 1. Field

The present disclosure relates to a battery cell manufacturing apparatus and a manufacturing method thereof. More specifically, it relates to a battery cell manufacturing apparatus and a manufacturing method thereof that improve the efficiency of the battery cell manufacturing process.

### 2. Description of the Related Art

The conventional manufacturing process for pouch-type battery cells may include inserting an electrode assembly into a case, filling it with electrolyte, and then performing a pre-charging step. Subsequently, the conventional manufacturing process for pouch-type battery cells may include a degassing step to vent gas generated during the pre-charging process.

Furthermore, to capture the gas generated during the initial charging process in the conventional pouch-type battery cell manufacturing process, the case may include a capture space formed separately from the receiving space accommodating the electrode assembly. Furthermore, prior to the degassing step, to discharge the gas collected in the collection space to the outside, the manufacturing process of the conventional pouch-type battery cell may include a step of forming a through hole that penetrates the case to connect the outside with the collection space.

However, damage to the case of a conventional pouch-type battery cell may occur during the degassing step, which discharges gas generated during the initial charging process. This is because the gas collected in the collection space is discharged through the through hole, causing the case to fold and potentially excessively alter its shape.

According to one aspect of the present disclosure, an object is to improve the efficiency of the battery cell manufacturing process.

According to another aspect of the present disclosure, an object is to improve the reliability of the battery cell manufacturing process.

According to yet another aspect of the present disclosure, an object is to prevent case folding and damage that may occur due to gas discharged into the collection space.

Meanwhile, the present disclosure may be widely applied in the fields of electric vehicles, battery charging stations, energy storage systems, and other green technologies utilizing batteries, such as photovoltaics and wind power. Furthermore, this invention may be used in eco-friendly mobility, including electric vehicles and hybrid vehicles, to suppress air pollution and greenhouse gas emissions, thereby preventing climate change.

### SUMMARY OF THE DISCLOSURE

A method for manufacturing a battery cell, including an electrode assembly; an electrolyte in which the electrode assembly is immersed; a case including a first receiving space accommodating the electrode assembly and the electrolyte; and a second receiving space spaced apart from the first receiving space and communicating with the first receiving space, using a battery cell manufacturing apparatus, the method according to an embodiment of the present disclosure may comprise: a step of pressing at least a portion of the first receiving space using a pressing member that moves to contact at least a portion of the first receiving space; a step of fixing at least a portion of the case using a fixing member that moves to contact at least a portion of the periphery of the case; and a step of punching a through hole penetrating the case corresponding to a portion of the second receiving space using a punching member that moves toward the second receiving space.

In an embodiment, the step of punching a through hole penetrating the case corresponding to a portion of the second receiving space may be performed after the step of pressing at least the portion of the first receiving space and the step of fixing at least a portion between the first receiving space and the second receiving space.

In an embodiment, the method may further comprise: a step of maintaining the pressure inside the chamber below the pressure of the second receiving space by using a pump discharging air inside the chamber where the battery cell is accommodated, and wherein the step of maintaining the pressure inside the chamber at or below the pressure of the second receiving space may include a step of discharging gas generated from the electrolyte and trapped in the second receiving space.

In an embodiment, the step of maintaining the pressure inside the chamber at or below the pressure of the second receiving space may be performed after the step of punching the through hole penetrating a portion of the second receiving space.

In an embodiment, the method may further comprise: a step of sealing the first receiving space by placing a sealing member between the first receiving space and the second receiving space, wherein the step of sealing the first receiving space may be performed after the step of maintaining the pressure inside the chamber at or below the pressure of the second receiving space.

In an embodiment, the method may further comprise: a step of maintaining the pressure inside the chamber at atmospheric pressure through the pump, wherein the step of maintaining the pressure inside the chamber at atmospheric pressure through the pump may be performed after the step of pressing at least the portion of the first receiving space through a pressurizing member that moves to contact at least the portion of the first receiving space and the step of fixing at least the portion of the case through the fixing member that moves to contact at least the portion of the periphery of the case.

In an embodiment, the step of maintaining the pressure inside the chamber at atmospheric pressure through the pump may be performed while the pressing member presses at least the portion of the first receiving space and the fixing member maintains a state of fixing at least the portion between the first receiving space and the second receiving space.

In an embodiment, the method may further comprise: a step of injecting the electrolyte into the first receiving space, and a step of charging and discharging the electrode assembly through a lead tab portion electrically connected to the electrode assembly and protruding outward, wherein the step of pressing at least the portion of the first receiving space may be performed after the step of injecting the electrolyte and the step of charging the electrode assembly.

A battery manufacturing apparatus for manufacturing the battery cell, including an electrode assembly; an electrolyte in which the electrode assembly is immersed; a case including a first receiving space accommodating the electrode assembly and the electrolyte; and a second receiving space spaced apart from the first receiving space and communicating with the first receiving space, the apparatus according to another embodiment of the present disclosure may comprise: a chamber including a space in which the battery cell is accommodated; a pump controlling the air inside the chamber to create a vacuum inside the chamber or to release the vacuum inside the chamber; a pressing member contacting at least a portion of the first receiving space and pressing at least a portion of the first receiving space; a fixing member contacting at least a portion of the periphery of the case and fixing at least a portion of the case; and a punching member that moves toward the second receiving space and forms a through hole penetrating a portion of the second receiving space.

In an embodiment, the fixing member may be arranged on a plane spaced apart from the first receiving space and the second receiving space by a predetermined interval.

In an embodiment, the fixing member may be arranged adjacent to each end of the second receiving space.

In an embodiment, the fixing member may have an inverted L-shape or a shape symmetrical to the inverted L-shape on a plane and surrounds at least a portion of the corners of the first receiving space adjacent to the second receiving space.

In an embodiment, the punching member may punch the through hole while the pressing member presses the first receiving space and the fixing member fixes at least a portion of the case.

In an embodiment, the pump may make the pressure inside the chamber at or lower than the pressure of the second receiving space or maintains the pressure inside the chamber at atmospheric pressure while the pressing member presses the first receiving space and the fixing member fixes at least a portion between the first receiving space and the second receiving space.

In an embodiment, the apparatus may further comprise: a sealing member disposed between the first receiving space and the second receiving space and sealing the first receiving space.

### BRIEF DESCRIPTION OF THE DRAWINGS

FIG. 1 is an example of a battery cell according to the present disclosure.

FIG. 2 illustrates one step of the manufacturing process for the battery cell according to the present disclosure.

FIG. 3 is a flowchart showing a battery cell manufacturing method according to an embodiment of the present disclosure.

FIG. 4, in parts (a) to (e), schematically illustrates each step of the battery cell manufacturing method according to an embodiment of the present disclosure.

FIG. 5 is a flowchart showing an example of performing the degassing step of FIG. 3.

FIG. 6 is a drawing showing an example of a degassing device according to an embodiment of the present disclosure.

FIGS. 7 to 10 are drawings showing the operation process of the degassing device according to an embodiment of the present disclosure.

FIG. 11 is a drawing showing a portion of a degassing device including a fixed member according to another embodiment of the present disclosure.

FIG. 12 is a block diagram showing an embodiment of a battery cell manufacturing device according to the present disclosure.

### DETAILED DESCRIPTION

The following describes in detail embodiments of the present disclosure with reference to the accompanying drawings. The configuration or manufacturing method of the apparatus described below is intended solely to illustrate the embodiments of the present disclosure and is not intended to limit the scope of the present disclosure. Reference numbers used throughout the specification denote the same components.

Specific terms used herein are intended solely for the convenience of description and are not intended to limit the exemplary embodiments described.

In this disclosure, the terms "battery," "battery cell," or "secondary battery" may all refer to the same rechargeable battery cell.

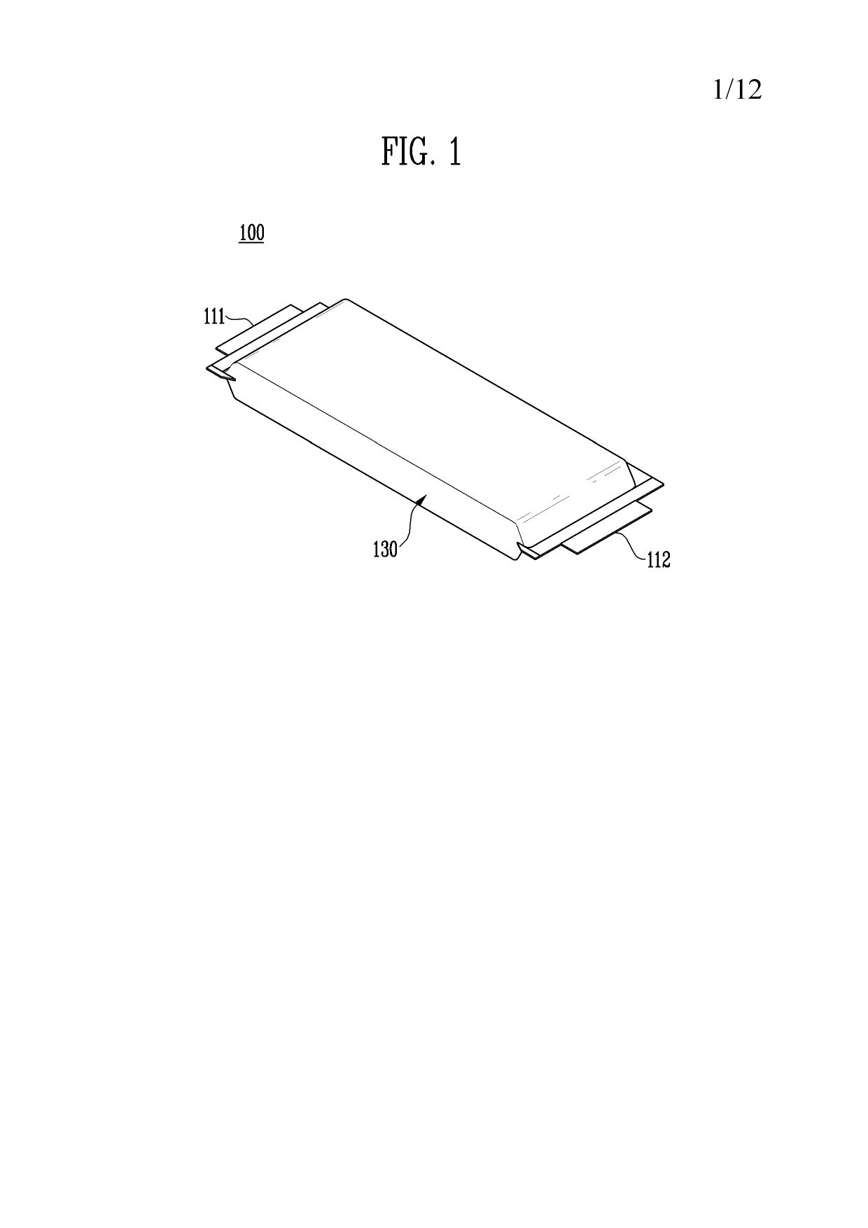

FIG. 1 is an example of a battery cell 100 according to the present disclosure.

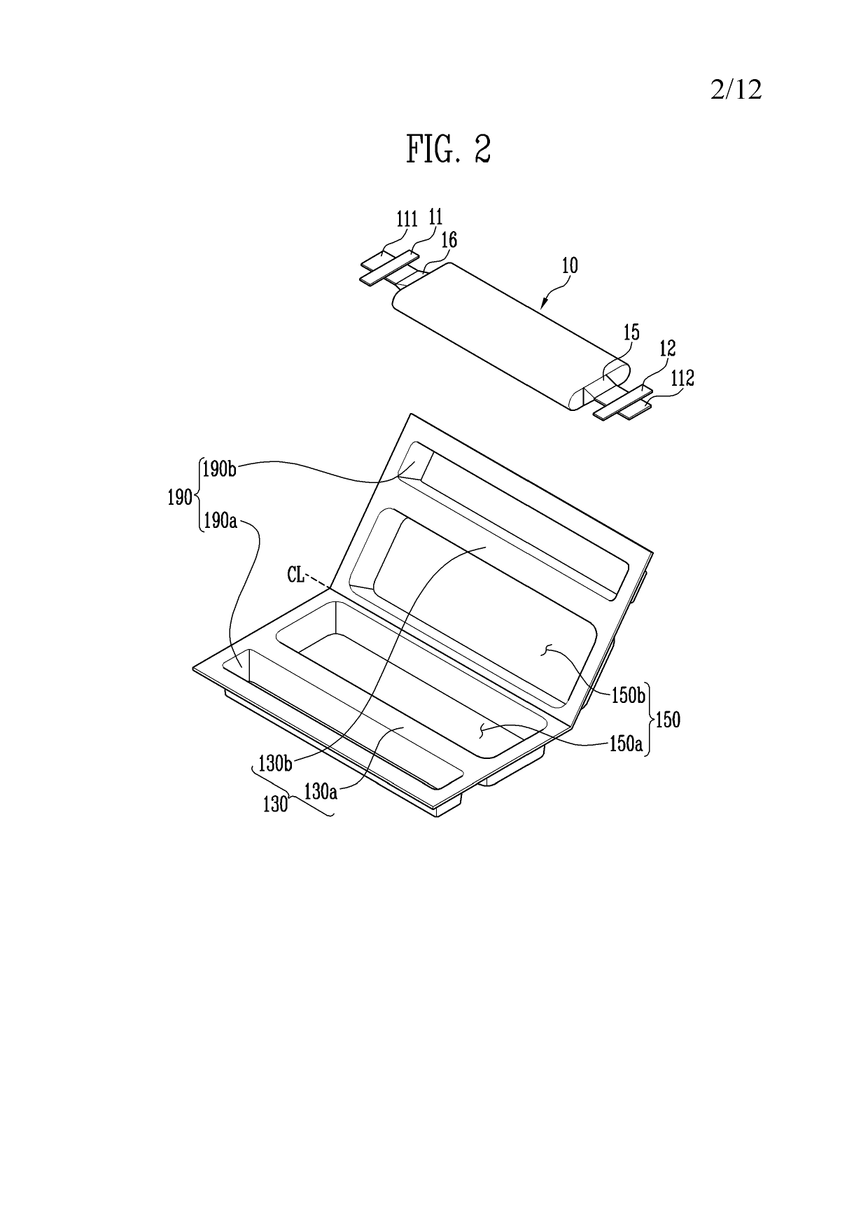

The battery cell 100 according to the present disclosure includes a case 130 that accommodates an electrode assembly 10 internally, referring to FIG. 2, and lead tabs 111, 112 that are electrically connected to the electrode assembly 10 and protrude outside the case 130.

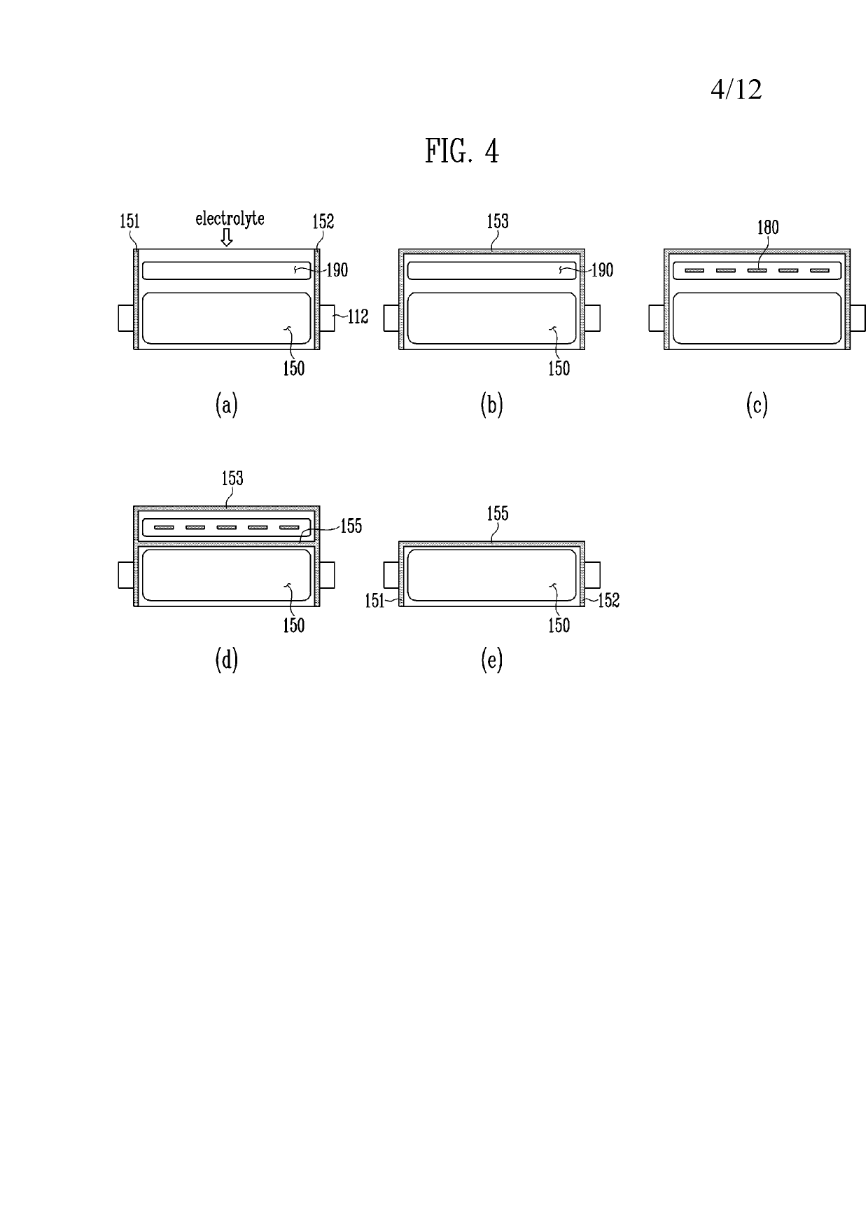

The case 130 may be formed from a flexible material and may contain the electrode assembly 10 and an electrolyte, referring to part (a) of FIG. 4, into which the electrode assembly is immersed. Meanwhile, the case 130 may be sealed at all openings to prevent leakage of the electrolyte to the outside.

Meanwhile, to activate the battery cell 100, the manufacturing process of the battery cell 100 may include a step of performing an initial charge-discharge on the battery cell 100. However, during the initial charge-discharge process, gas may inevitably be generated from the electrolyte. Since failure to remove gas generated inside the case 130 may cause battery cell defects, the process for removing the gas is considered an essential process in the manufacturing process of the battery cell.

That is, the battery cell manufacturing process may perform a degassing process to remove the gas. Meanwhile, to efficiently remove the gas during the degassing process, a space for trapping the gas inside the battery cell 100 will be required.

FIG. 2 illustrates one step of the manufacturing process for the battery cell 100 according to the present disclosure.

Specifically, FIG. 2 illustrates a step in a manufacturing process for manufacturing a battery cell 100 where capturing and degassing gas generated inside the battery cell 100 is considered.

Referring to FIG. 2, the manufacturing method for the battery cell according to the present disclosure may place the electrode assembly 10 inside the case 130.

The electrode assembly 10 may be formed by sequentially laminating a positive electrode, a separator, and a negative electrode. The positive and negative electrodes may be separated by the separator to prevent mutual contact.

The battery cell 100 may include lead tab portions 111, 112 connected to the electrode assembly 10 and protruding outward. The electrode assembly 10 may be inserted into the case 130 after being connected to the lead tab portions 111, 112. Therefore, when the electrode assembly 10 is placed inside the case 130, at least a portion of the lead tab portions 111, 112 will be positioned to protrude outside the case 130.

The lead tab portions 111, 112 may be formed by grouping the leads 15, 16 protruding from the positive electrode and the negative electrode respectively according to polarity, and then combining them with the tab portions. To protect the region where the leads 15, 16 and the tabs are connected and to seal with the case 130, the battery cell 100 may include a lead film or sealant, 11, 12 at the region where the leads 15, 16 and the tabs are connected.

Meanwhile, the case 130 may include a first receiving space 150 for accommodating the electrode assembly 10 and a second receiving space 190 for capturing gas generated during the manufacturing process of the battery cell 100. Depending on the embodiment, the battery cell 100 may refer to a battery cell 100 in which the battery cell manufacturing process according to the embodiments of the present disclosure has been fully performed and the second receiving space 190 has been cut. However, for convenience of description, the battery cell 100 may also be referred to below as including a case 130 with the second receiving space 190 uncut.

Generally, the case 130 may be formed by folding a single sheet in half. For this purpose, the case 130 may include a first part 130a forming one portion of the sheet, and a second part 130b forming another portion of the sheet.

Furthermore, the first part 130a may be a rectangular sheet, and the second part 130b may also be a sheet of the same shape. That is, the size of the first part 130a and the second part 130b may be identical. Moreover, the second part 130b may extend from a corner CL of the first part 130a, such that the first part 130a and the second part 130b may be formed integrally. That is, the first part 130a and the second part 130b may be connected to each other at the one corner CL.

Since the first part 130a and the second part 130b are folded and joined with respect to the one corner CL, the one corner CL may be referred to as a folding line.

Meanwhile, the first part 130a may include a first recessed space 150a formed by one surface being recessed, and a first concave space 190a positioned spaced apart from the first recessed space 150a and formed by being recessed in the same direction as the first recessed space 150a.

Similarly, the second part 130b may include a second recessed space 150b formed by being recessed in the same direction as the first recessed space 150a, and a second concave space 190b that is spaced apart from the second recessed space 150b and formed by being recessed in the same direction as the first recessed space 150a.

When the first part 130a and the second part 130b are folded along the folding line CL, the first recessed space 150a and the second recessed space 150b may form the first receiving space 150.

Similarly, when the first part 130a and the second part 130b are folded along the folding line CL, the first concave space 190a and the second concave space 190b may form the second receiving space 190.

Before folding the first part 130a and the second part 130b, the first recessed space 150a, the second recessed space 150b, the first concave space 190a, and the second concave space 190b of the folding line CL may all be shaped to open in the same direction.

When the first part 130a and the second part 130b are folded and joined along the folding line CL, the opening of the first recessed space 150a and the opening of the second recessed space 150b overlap each other, ultimately forming a single first receiving space 150 from the first recessed space 150a and the second recessed space 150b.

Similarly, when the first part 130a and the second part 130b are folded and joined together, the opening of the first concave space 190a and the opening of the second concave space 190b overlap with each other, ultimately causing the first concave space 190a and the second concave space 190b to form a single first receiving space 150.

Meanwhile, the volume of the first receiving space 150 may be larger than the volume of the second receiving space 190. This is because the gas may be compressed and therefore does not need to occupy a volume larger than the first receiving space 150.

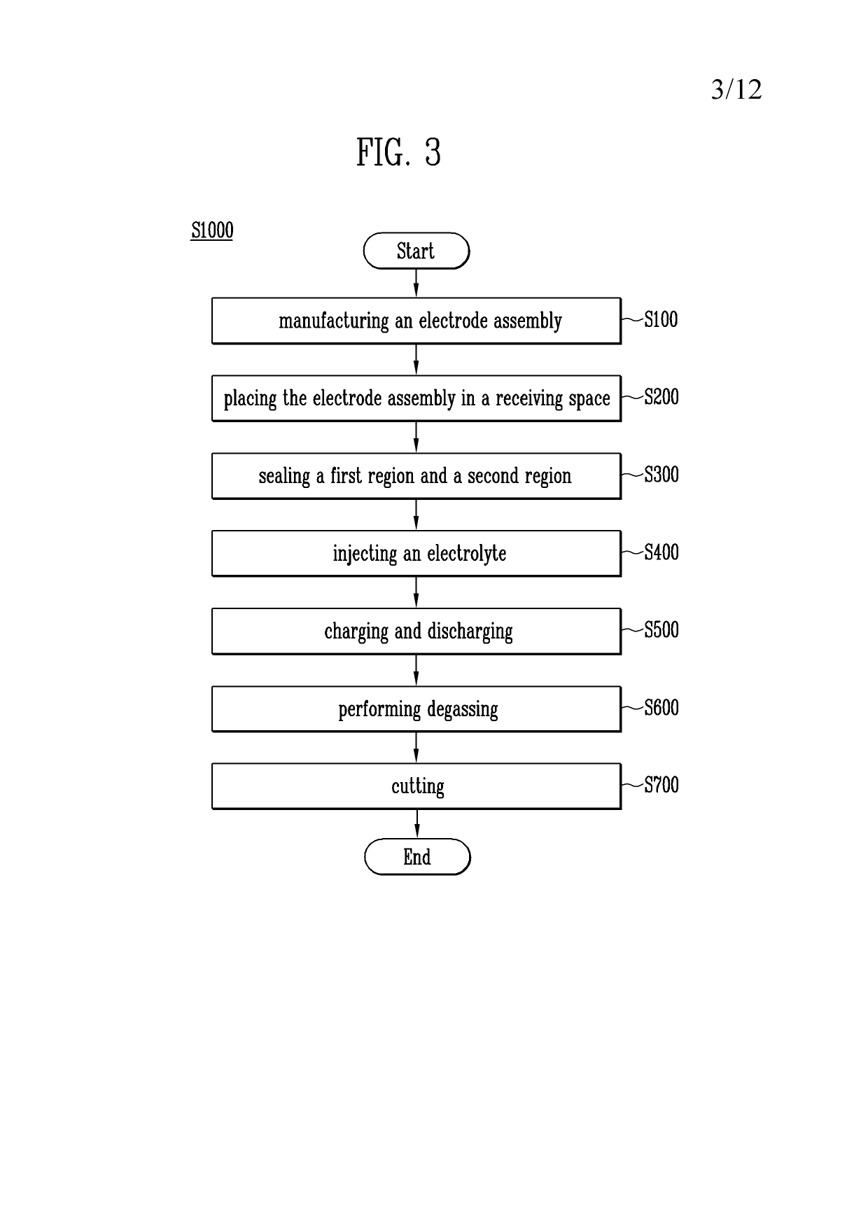

FIG. 3 is a flowchart showing a battery cell manufacturing method according to an embodiment of the present disclosure. FIG. 4, in parts (a) to (e), schematically illustrates each step of the battery cell manufacturing method according to an embodiment of the present disclosure.

Referring to FIGS. 1 to 3, the battery cell manufacturing method S1000 according to the present disclosure may include a step S100 of manufacturing an electrode assembly 10, a step S200 of placing the electrode assembly 10 in the first receiving space 150 in the case 130 including a first receiving space 150 and a second receiving space 190 arranged spaced apart from the first receiving space 150, a step S300 of sealing the first region 151 and the second region 152, a step S400 of injecting an electrolyte toward the first receiving space 150, a step S500 of charging and discharging the electrode assembly 10 through the lead tab portions 111, 112, a step S600 of performing degassing, and a step S700 of cutting between the fourth region 155 and the second receiving space 190.

According to an embodiment, the step S600 of performing degassing may be performed after the step S400 of injecting the electrolyte toward the first receiving space 150 and the step S500 of charging and discharging the electrode assembly 10 through the lead tab portions 111, 112.

Referring to FIG. 3 and part (a) of FIG. 4, the electrode assembly 10 may be placed in the first receiving space 150 inside the case 130 that forms the first receiving space 150 and the second receiving space 190. This step may be included in the step S200 of placing the electrode assembly 10 in the first receiving space 150. Subsequently, the battery cell 100 manufacturing method according to this disclosure may perform a step of sealing a portion of the case 130 that includes the region where the lead tab portions 111, 112 protrude.

Since the case 130 is formed such that the first part 130a and the second part 130b fold based on the folding line CL, it will be necessary to seal the remaining area excluding the folding line CL to prevent leakage of the electrolyte accommodated in the first receiving space 150. That is, prior to sealing, the case 130 will be in a form where all three sides of the case 130 are open, except for the folding line CL.

Referring to FIG. 3 and part (a) of FIG. 4, prior to injecting the electrolyte, the manufacturing method for the battery cell 100 according to this disclosure may seal a first region 151 and a second region 152 of the case 130, which are regions including portions where the lead tab portions 111, 112 protrude. This step may be included in the step S300 of sealing the first area and the second area.

Although part (a) of FIG. 4 illustrates an example configuration where the lead tab portions 111, 112 protrude bilaterally, the lead tab portions 111, 112 may also protrude in the same direction. In this case, the method for manufacturing the battery cell 100 according to the present disclosure may include sealing the first region 151 and the second region 152 of the case 130, which is a portion of the case 130 including the portion where the lead tab portions 111, 112 protrude.

The first region 151 and the second region 152 may be regions including the left and right corners of the front surface of the case 130, where the front surface is defined as the surface facing the surface onto which the electrode assembly 10 is stacked. That is, the electrode assembly 10 may be positioned between the first region 151 and the second region 152.

The first region 151 will be formed by the joining and sealing of the first part 130a and the second part 130b. That is, the first region 151 may be formed by portions that each form a corner of the first part 130a and the second part 130b, respectively, before the first part 130a and the second part 130b are folded. After the respective corners of the first part 130a and the second part 130b are joined in correspondence with each other, the battery cell manufacturing method according to the present disclosure may form the first region 151 through heating or pressing and sealing.

Similarly, the second region 152 will also be formed by the joining and sealing of the first part 130a and the second part 130b. That is, the second region 152 may be formed by the regions that each form the other edge of the first part 130a and the second part 130b before folding the first part 130a and the second part 130b. After the other edges of the first part 130a and the second part 130b are joined in correspondence with each other, the battery cell manufacturing method according to the present disclosure may form the second region 152 through heating or pressurization and sealing.

Upon sealing the first region 151 and the second region 152, the case 130 will be in a sealed state, except for a third region 153, referring to part (b) of FIG. 4, including the upper edge of the case 130.

Referring to FIG. 3 and part (a) of FIG. 4, the battery cell manufacturing method according to this disclosure may supply electrolyte from the top of the case 130 toward the first receiving space 150 after sealing the first region 151 and the second region 152. The electrolyte is accommodated in the first receiving space 150 in a predetermined weight or predetermined amount, thereby immersing the electrode assembly 10. The electrode assembly 10 may be submerged in the liquid electrolyte. This step may be included in the step S400 of injecting the electrolyte.

Referring to part (b) of FIG. 4, after injecting the electrolyte into the first receiving space 150, the battery cell manufacturing method according to this disclosure may perform a step of sealing other regions of the case 130 that include the portion where the electrolyte is injected.

The other area is the area opened to inject the electrolyte solution, referred to herein as the third region 153. The third region 153 may be the region including the remaining corners excluding the corners included in the first region 151 and the second region 152. That is, the third region may be the region located on the upper side of the case 130. Like the first region 151 and the second region 152, the third region 153 may be formed by sealing it through pressurization or heating.

Meanwhile, the first receiving space 150 and the second receiving space 190 are sealed but remain in a state where they may communicate with each other. That is, since they are sealed by being joined along the periphery of the case 130, the remaining regions of the case 130 will simply have the first part 130a and the second part 130b in contact with each other. Therefore, the first receiving space 150 and the second receiving space 190 may communicate with each other. This allows gas generated from the electrolyte contained in the first receiving space 150 to move into the second receiving space 190.

Upon completion of sealing the third region 153, the battery cell manufacturing method according to the present disclosure may perform a step of charging while applying pressure to the electrode assembly via the lead tab portions 111, 112. This step may be included in the initial charging step S500 of FIG. 3. Depending on the embodiment, the initial charging step S500 may be an initial charging step that charges the battery cell 100 while pressurizing it.

Since the case 130 is sealed, this gas cannot be discharged externally but may accumulate in the second receiving space 190. That is, the second receiving space 190 may be a space intentionally designed to effectively capture gas generated from the electrolyte.

Referring to FIG. 3 and part (c) of FIG. 4, to discharge the gas collected in the second receiving space 190 during the initial charging step, the battery cell manufacturing method according to the present disclosure may perform a step of punching a through hole 180 that penetrates a portion of the case 130 forming the second receiving space 190.

The through holes 180 may be provided in a plurality and may be formed by penetrating the bottom surface of the first recessed space 190a and the bottom surface of the second recessed space 190b.

The plurality of through holes 180 may communicate between the second receiving space 190 and the exterior. Therefore, gas collected in the second receiving space 190 may be discharged to the exterior through the plurality of through holes 180.

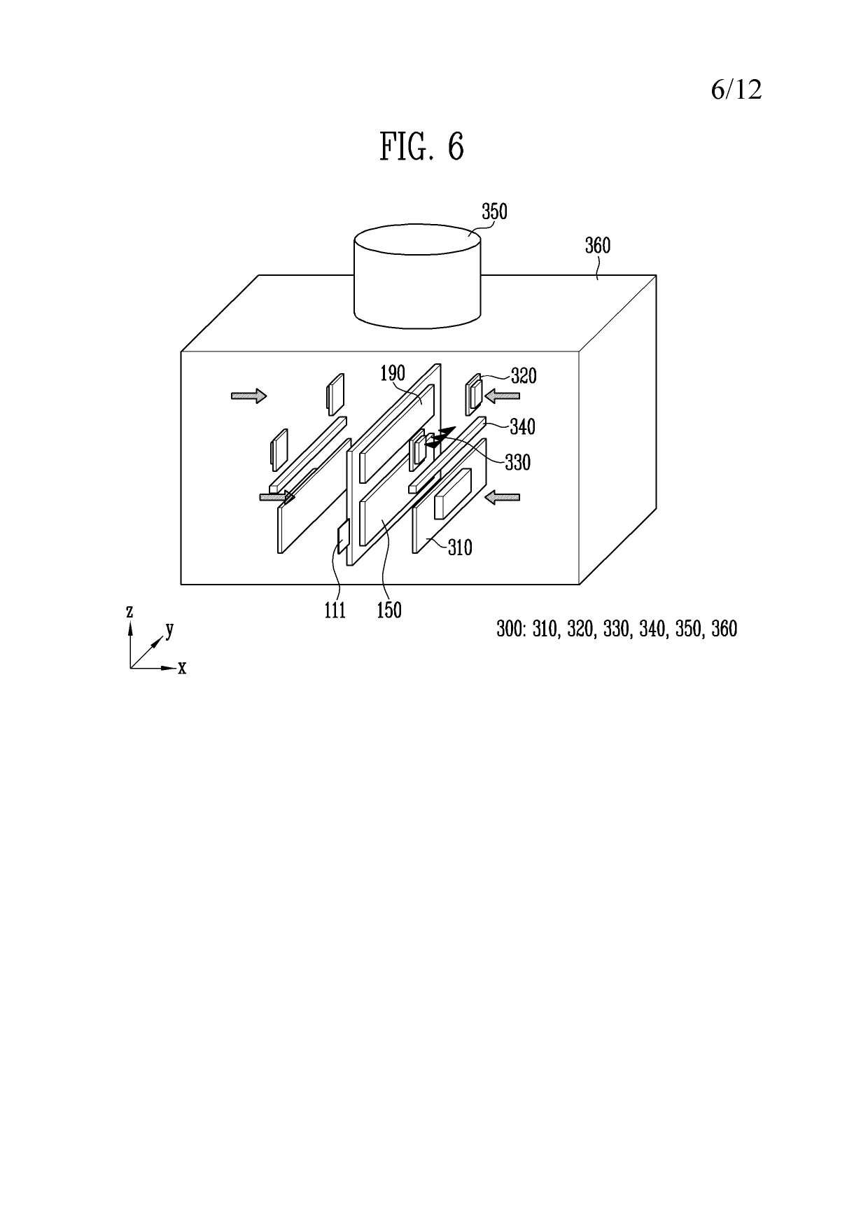

Meanwhile, according to the comparative example, when gas collected in the second receiving space 190 is discharged through the through hole 180, at least a portion of the case 130 may be folded and damaged, creating a risk that the insulating state of the case 130 is not maintained. For example, when the gas is discharged through the through hole 180, folding of the case 130 and deterioration of the insulation resistance may occur in the peripheral regions of the first receiving space 150 and the second receiving space 190. For instance, while the insulation resistance of a portion of the case 130 should be maintained at a constant level, the occurrence of the aforementioned folding phenomenon damages that portion of the case 130, potentially causing a failure in the insulation resistance of the case 130. According to the degassing device 300, referring to FIG. 6, the folding phenomenon of the case 130 may be prevented. Details are described below.

Referring to part (d) of FIG. 4, the battery cell manufacturing method according to the present disclosure may perform a step of sealing a preset fourth region 155 located between the first receiving space 150 and the second receiving space 190 in the case 130. For example, in this step, a sealing member 340, referring to FIG. 6, may be placed in the fourth region 155.

That is, the battery cell manufacturing method according to this disclosure may seal the fourth region 155, which is located between the first receiving space 150 and the second receiving space 190 and extends from the first region 151 to the second region 152.

Through the sealing of the fourth region 155, the second receiving space 190 and the first receiving space 150 may be separated and isolated from each other. The first region 151, the second region 152, and the third region 153, the fourth region 155 will also be formed by pressurizing or heating after a portion of the first part 130a corresponding to the fourth region 155 and another portion of the second part 130b are joined.

According to the embodiment, after the step of punching the through hole 180, the interior of the chamber 360, referring to FIG. 6, may be evacuated to a vacuum. Subsequently, the preset fourth region 155 located between the first receiving space 150 and the second receiving space 190 may be sealed, and the vacuum inside the chamber 360 may be released.

Referring to part (e) of FIG. 4, after sealing the fourth region 155, since the second receiving space 190 is no longer needed, the battery cell manufacturing method according to this disclosure may perform a step of cutting between the fourth region 155 and the second receiving space 190. Through this cutting, the battery cell manufacturing method according to the present disclosure may obtain the final shape of the battery cell 100 shown in part (e) of FIG. 4.

According to an embodiment, the battery cell manufacturing method may repeatedly perform the charging step S500 and the degassing step S600 prior to the cutting step S700.

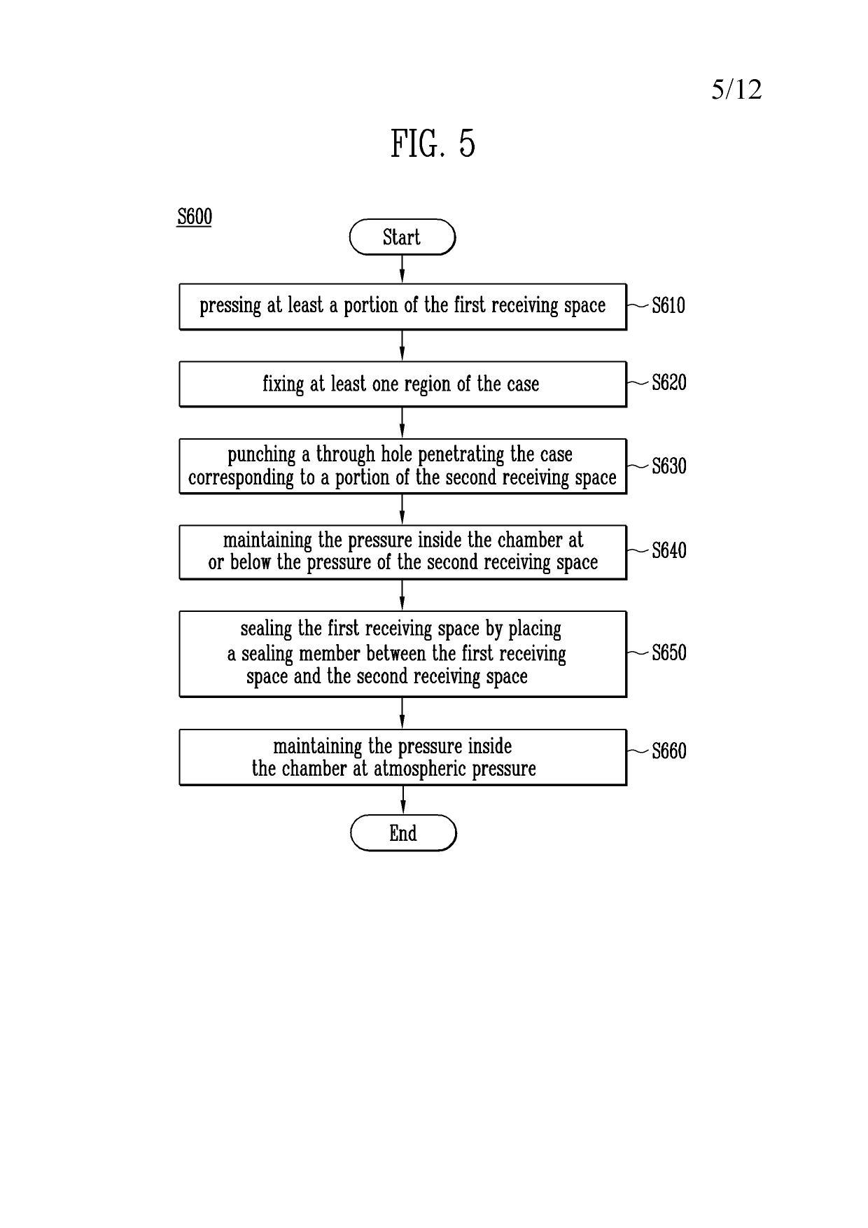

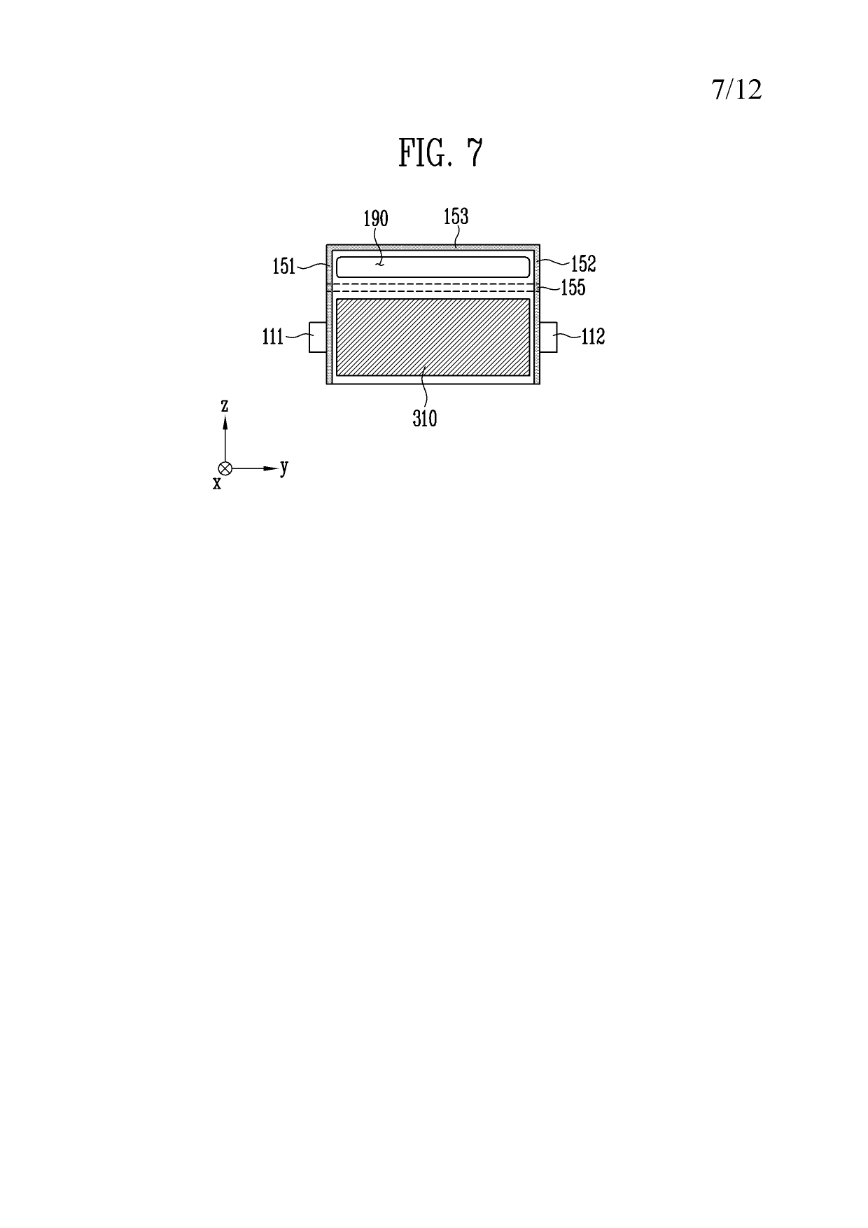

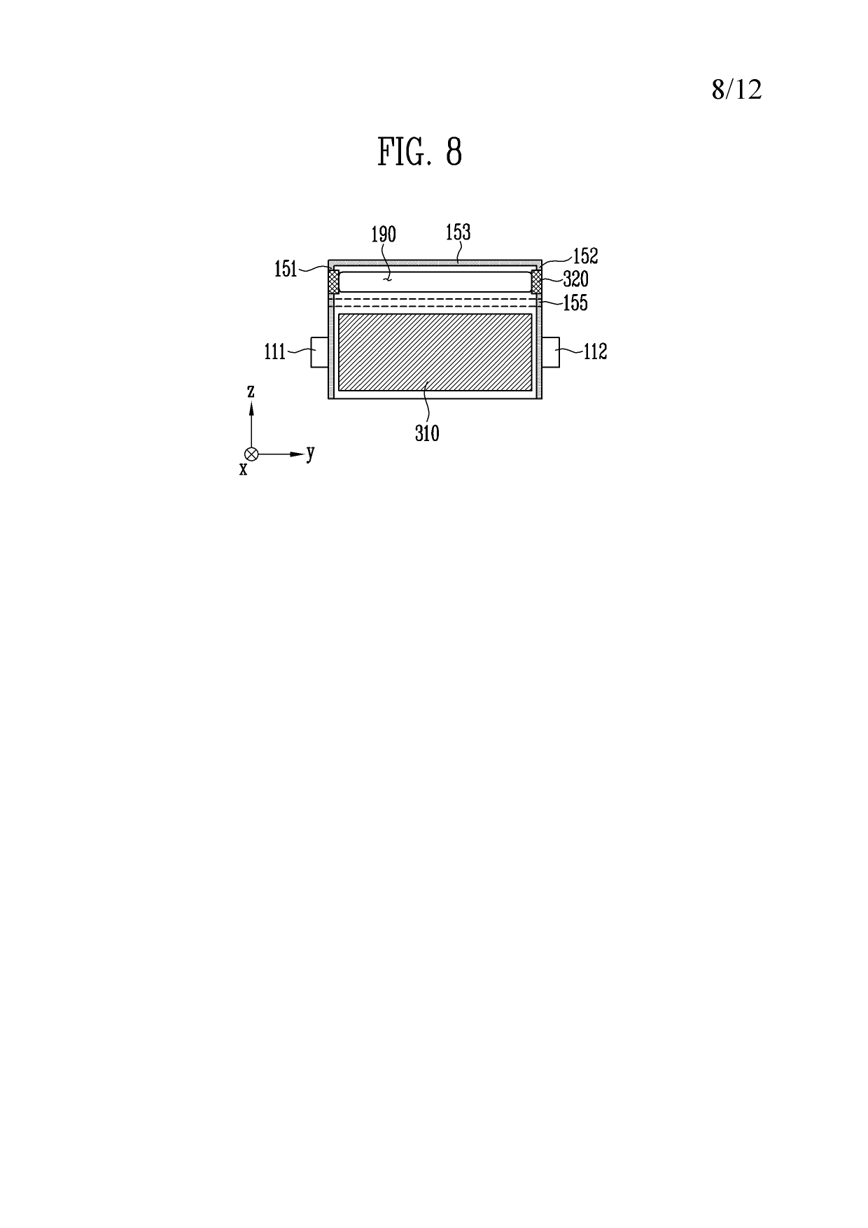

FIG. 5 is a flowchart showing an example of performing the degassing step of FIG. 3. FIG. 6 is a drawing showing an example of a degassing device according to an embodiment of the present disclosure. FIGS. 7 to 10 are drawings showing the operation process of the degassing device according to an embodiment of the present disclosure. For ease of explanation, details in the configuration and operation process of the degassing device shown in FIGS. 5 to 10 that overlap with those described in FIGS. 1 to 4 are omitted.

Referring to FIGS. 1 to 5, the step S600 of performing degassing according to the present disclosure comprises: a step S610 of pressing at least a portion of the first receiving space 150; a step S620 of fixing at least one region of the case 130; a step S630 of punching a through hole 180, referring to FIG. 6, penetrating the case 130 corresponding to a portion of the second receiving space 190, a step S640 of maintaining the pressure inside the chamber 360, referring to FIG. 6, at or below the pressure of the second receiving space 190, a step S650 of sealing the first receiving space 150 by placing a sealing member 340, referring to FIG. 6 between the first receiving space 150 and the second receiving space 190, and a step S660 of maintaining the pressure inside the chamber 360 at atmospheric pressure.

Hereinafter, the step S600 of performing degassing according to an embodiment of the present disclosure is described based on the operation process of the degassing device 300 according to an embodiment of the present disclosure.

Referring to FIG. 6, the degassing device 300 according to an embodiment of the present disclosure may include a pressing member 310, a fixing member 320, a punching member 330, a sealing member 340, a pump 350, and a chamber 360.

Referring to FIGS. 5 to 7, the pressing member 310 contacts at least a portion of the first receiving space 150 and may press at least a portion of the first receiving space 150. For example, one or more pressing members 310 may move in each direction facing both sides of the first receiving space 150, e.g., the x direction or the opposite direction of the x direction. Accordingly, the pressing member 310 may contact at least a portion of the first receiving space 150 and press the first receiving space 150.

According to an embodiment, the pressing member 310 may cover an entire surface of the first receiving space 150. For example, the size of the pressing member 310 in the plane may be larger than or equal to the size of the first receiving space 150 in the plane. However, this is not limited thereto. In another embodiment, the pressing member 310 may cover only at least a portion of one surface of the first receiving space 150. For example, the size of the pressing member 310 in the plane may be smaller than the size of the first receiving space 150 in the plane.

Referring to FIGS. 5 to 8, the fixing member 320 may move to contact at least a portion of the periphery of the case 130, referring to FIG. 2, to fix at least one region of the case 130. For example, one or more fixing members 320 may move in the x direction or in the direction opposite to the x direction to contact the top upper portion of the periphery of the case 130 and fix a portion of the case 130.

According to an embodiment, the fixing member 320 may be arranged adjacent to each end of the second receiving space 190. For example, the fixing member 320 may contact at least a portion of each of the first region 151 and the second region 152. In other words, the fixing member 320 may contact a portion of the top edge of both the first region 151 and the second region 153.

According to an embodiment, the fixing member 320 may be arranged on a plane so as not to overlap with the first receiving space 150 and the second receiving space 190. For example, the fixing member 320 may be positioned adjacent to both ends of the second receiving space 190 while being spaced apart from the second receiving space 190 by a predetermined interval.

The fixing member 320 may fix at least a portion of the periphery of the second receiving space 190. The fixing member 320 contacts a portion of the first region 151 and the second region 152, preventing folding of a portion of the periphery of the second receiving space 190 during the degassing process. For example, when a punching member 330 punches a through hole 180, gas inside the second receiving space 190 may be exhausted. During this exhausting process, folding of a portion of the case 130, referring to FIG. 2, may occur. For example, folding may occur in at least a portion of one end of the fourth region 155. According to an embodiment of the present disclosure, the pressing member 310 may press the first receiving space 150. Subsequently, the fixing member 320 may fix at least a portion of the top part of the periphery of the case 130, referring to FIG. 2, thereby preventing the aforementioned folding phenomenon of a portion of the case 130 and reducing the insulation resistance failure rate.

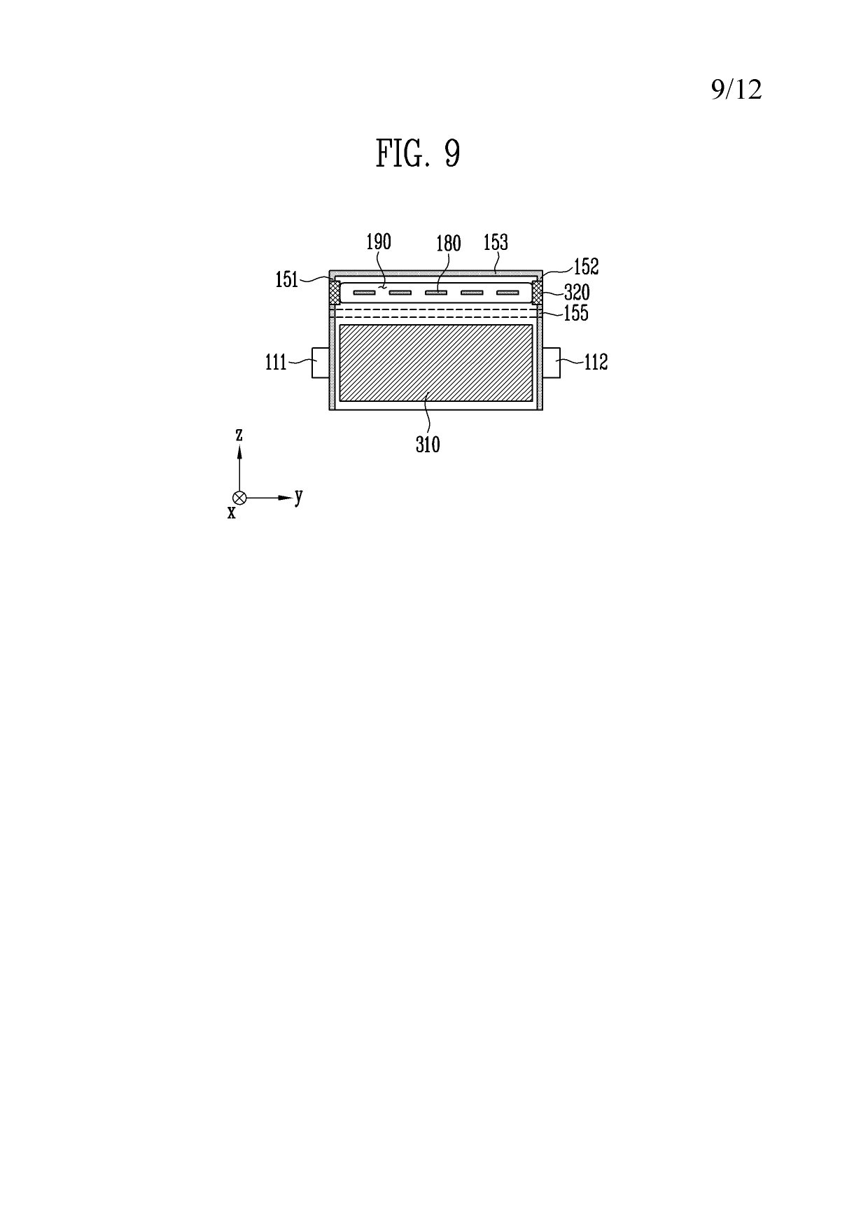

Referring to FIGS. 5 through 9, the punching member 330 may move in a direction toward the second receiving space 190 to punch a through hole 180 that penetrates a portion of the second receiving space 190. For example, the punching member 330 may move in the x direction to punch one or more through holes 180 in the second receiving space 190. The through hole 180 in FIG. 9 may be described similarly to the through hole 180 in part (c) of FIG. 4. Hereinafter, redundant descriptions are omitted.

The degassing device 300 according to an embodiment of the present disclosure may punch through the through holes 180 while the pressing member 310 presses the first receiving space 150 and the fixing member 320 fixes at least one region of the case 130, referring to FIG. 2. That is, according to the embodiment, the step S630 of punching a through hole 180 penetrating the case, referring to FIG. 2, corresponding to a portion of the second receiving space 190 may be performed after the step S610 of pressing at least the portion of the first receiving space 150 and the step S620 of fixing at least a portion between the first receiving space 150 and the second receiving space 190. Accordingly, when gas is exhausted through the through hole 180, folding of a portion of the case 130 may be prevented.

The degassing device 300 can create a vacuum inside the chamber 360 via the pump 350. Depending on the implementation, after this step, the degassing device 300 may create a vacuum inside the chamber 360. For example, the step S640 of maintaining the pressure inside the chamber 360 at or below the pressure of the second receiving space 190 may be performed after the step S630 of punching a through hole 180 penetrating the case 130 corresponding to a portion of the second receiving space 190.

Depending on the embodiment, the step S640 of maintaining the pressure inside the chamber 360 at or below the pressure of the second receiving space 190 may include a step of discharging gas generated in the electrolyte and collected in the second receiving space 190. For example, if the pump 350 creates a vacuum inside the chamber 360, the gas trapped in the second receiving space 190 may be discharged through the through hole 180.

According to an embodiment, the pump 350 may be a piston pump. However, it is not limited thereto. For example, the pump 350 may be a rotary vane pump.

Referring to FIGS. 6 to 10, the sealing member 340 may be disposed on the fourth region 155. According to an embodiment, the fourth region 155 may be a region extending in the y-direction between the first region 151 and the second region 152.

According to an embodiment, the sealing member 340 may be disposed between the first receiving space 150 and the second receiving space 190. Accordingly, the sealing member 340 may seal the first receiving space 150. Accordingly, the first receiving space 150 may not be in communication with the second receiving space 190.

According to an embodiment, the step S650 of sealing the first receiving space 150 by placing the sealing member 340 between the first receiving space 150 and the second receiving space 190 may be performed after the step S640 of maintaining the pressure inside the chamber 360 at or below the pressure of the second receiving space 190. Accordingly, the fourth region 155 may be sealed while a portion of the case 130, referring to FIG. 2, remains unfolded. For example, the fourth region 155 may be sealed while the peripheral portions of the first receiving space 150 and the second receiving space 190 remain unfolded.

The degassing device 300 may release the vacuum inside the chamber 360. For example, the degassing device 300 may inject air into the chamber 360 via the pump 350 to release the vacuum inside the chamber 360. According to an embodiment, the step S660 of maintaining the pressure inside the chamber 360 at atmospheric pressure may be performed after the step S650 of sealing the first receiving space 150 by placing a sealing member 340 between the first receiving space 150 and the second receiving space 190.

At this time, according to the comparative example, when the interior of the chamber 360 is made into a vacuum, or when the vacuum is released, a folding phenomenon may occur in a portion of the case 130, referring to FIG. 2. For example, during the release of the vacuum inside the chamber 360, air may enter and exit through the through hole 180 of the second receiving space 190, posing a risk of folding occurring in at least a portion of the case 130.

In contrast, according to the embodiment of the present disclosure, the pressing member 310 may maintain a state of pressurizing the first receiving space 150. Furthermore, the fixing member 320 may maintain a state of fixing at least a portion of the periphery of the second receiving space 190. Accordingly, the degassing device 300 according to the embodiment of the present disclosure may prevent folding phenomena from occurring in a portion of the case 130 when the interior of the chamber 360 is made into a vacuum or during the release of the vacuum inside the chamber 360.

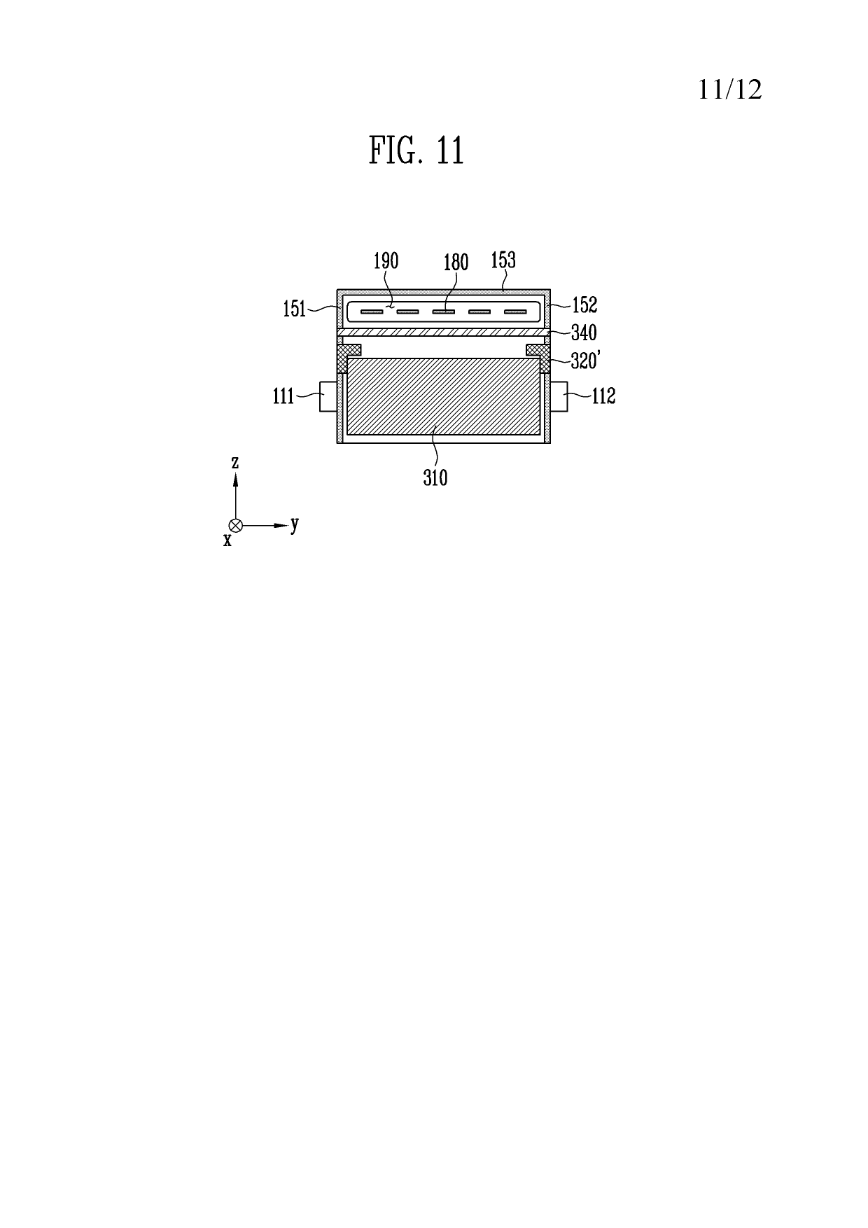

FIG. 11 is a drawing showing a portion of a degassing device including a fixed member according to another embodiment of the present disclosure.

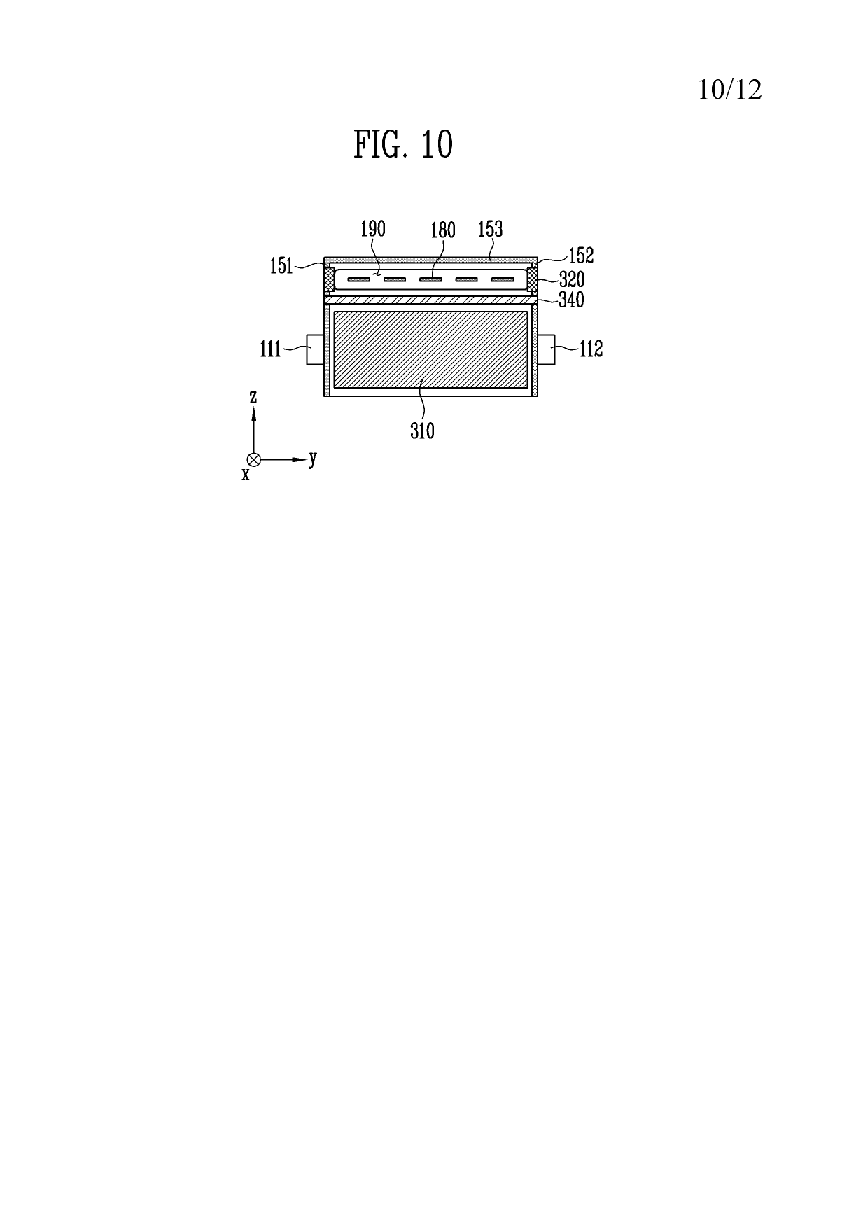

Referring to FIG. 11, the degassing device 300 may include a fixing member 320’. The fixing member 320’ may be positioned at the bottom end of the sealing member 340. For example, while the fixing member 320 in FIG. 10 is positioned at the top end of the sealing member 340, the fixing member 320’ in FIG. 11 may be positioned at the bottom end of the sealing member 340.

The fixing member 320’ may have an inverted L-shape or a shape symmetrical to the inverted L-shape. For example, the fixing member 320’ positioned on the first region 151 may have an inverted L-shape. Furthermore, the fixing member 320’ positioned on the second region 152 may have a shape symmetrical to the inverted L-shape.

The fixing member 320’ may be arranged to surround at least some of the corners of the first receiving space 150 that are adjacent to the second receiving space 190. For example, the fixing member 320’ may be arranged to surround each of the corners of the first receiving space 150 that are adjacent to the second receiving space 190 in the z-direction.

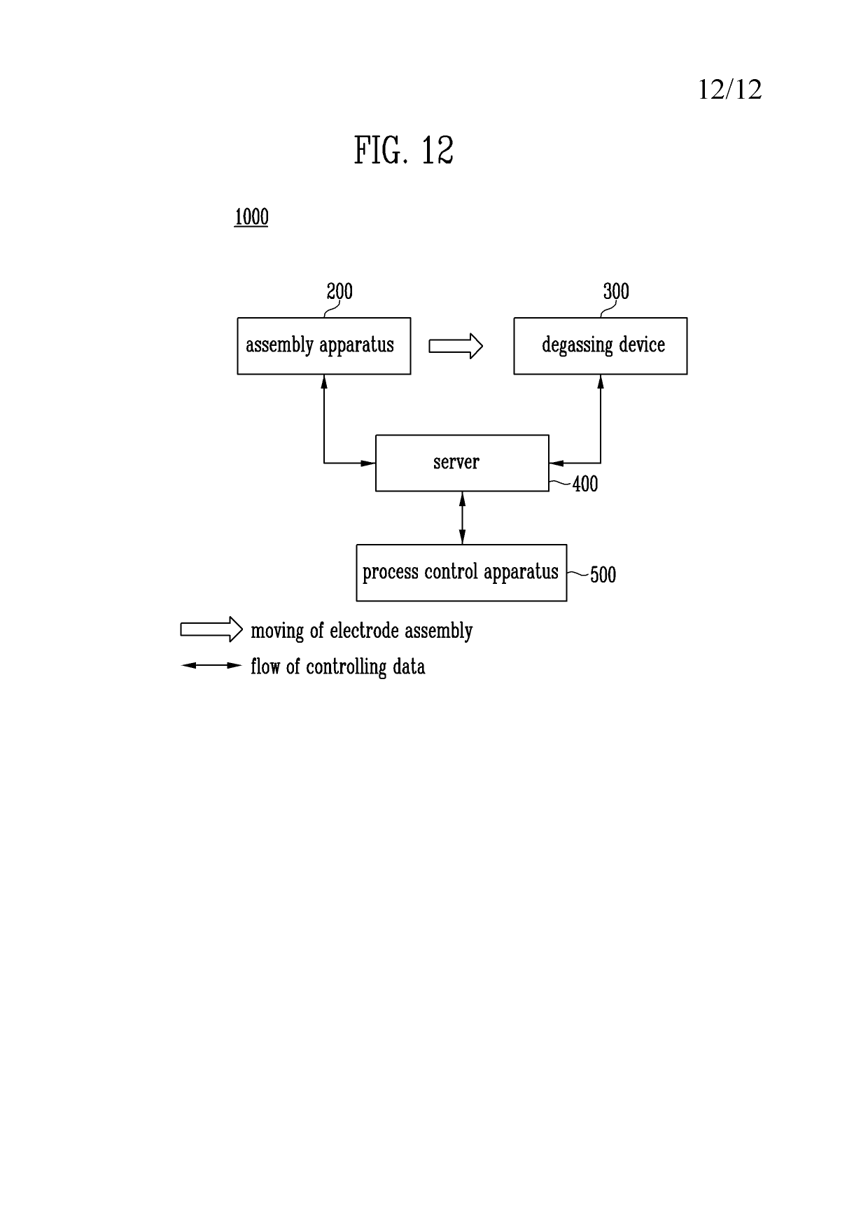

FIG. 12 is a block diagram showing an embodiment of a battery cell manufacturing device according to the present disclosure.

Referring to FIG. 12, the battery cell manufacturing apparatus 1000 according to the present disclosure may include an assembly apparatus 200, a degassing apparatus 300, a server 400, and a process control apparatus 500. Meanwhile, the degassing device 300 in FIG. 12 may be described similarly to the degassing device 300 in FIG. 6. Hereinafter, redundant descriptions are omitted.

The battery cell manufacturing apparatus 1000 may be moved to the assembly apparatus 200 according to the present disclosure. At this time, the battery cell manufacturing device 1000 may include a transport member capable of transporting the battery cell 100.

The assembly device 200 may perform an assembly process to mechanically assemble a battery cell 100, referring to FIG. 1, using a manufactured electrode assembly 10, referring to see FIG. 2. For example, the assembly device 200 may manufacture a battery cell 100 including an electrode assembly 10, an electrolyte for immersing the electrode assembly 10, and a case 130 including a first receiving space 150 and a second receiving space 190 for accommodating the electrode assembly 10 and the electrolyte.

The battery cell manufacturing apparatus 1000 may include an assembly device 200, a degassing device 300, and a server 400 containing data regarding the progress status of the ongoing battery cell 100 manufacturing process.

The battery cell manufacturing apparatus 1000 may include a process control device 500 that controls the assembly device 200, the degassing device 300, and the server 400. The process control device 500 may be installed in a single control room within the battery cell manufacturing device 1000 to manage the assembly device 200, degassing device 300, and server 400 in an integrated manner. Depending on the implementation example, the process control device 500 may also be used as a term referring to all control units individually included in the assembly device 200, degassing device 300, and server 400.

According to the embodiment, the process control device 500 may receive data from the server 400 regarding the progress status of the manufacturing process of the battery cell 100. Accordingly, the process control device 600, referring to FIG. 6, may drive one of the pressing member 310, fixing member 320, perforating member 330 and pump 350 of the degassing device 300 based on the received data. For example, the process control device 600 may move the pressing member 310 toward the first receiving space 150 so that the pressing member 310 presses at least a portion of the first receiving space 150. However, this is merely illustrative and not limiting.

The present disclosure may be practiced in various forms of modification, and the scope of rights is not limited to the above-described embodiments. Therefore, if a modified embodiment includes the components of the claims of the present disclosure, it should be considered within the scope of rights of the present disclosure.

What is claimed is:

1. A method for manufacturing a battery cell, including an electrode assembly; an electrolyte in which the electrode assembly is immersed; a case including a first receiving space accommodating the electrode assembly and the electrolyte; and a second receiving space spaced apart from the first receiving space and communicating with the first receiving space, using a battery cell manufacturing apparatus, the method comprising:
a step of pressing at least a portion of the first receiving space using a pressing member that moves to contact at least a portion of the first receiving space;
a step of fixing at least a portion of the case using a fixing member that moves to contact at least a portion of the periphery of the case; and
a step of punching a through hole penetrating the case corresponding to a portion of the second receiving space using a punching member that moves toward the second receiving space.

2. The method according to claim 1, wherein the step of punching a through hole penetrating the case corresponding to a portion of the second receiving space is performed after the step of pressing at least the portion of the first receiving space and the step of fixing at least a portion between the first receiving space and the second receiving space.

3. The method according to claim 2, further comprising:
a step of maintaining the pressure inside the chamber below the pressure of the second receiving space by using a pump discharging air inside the chamber where the battery cell is accommodated, and
wherein the step of maintaining the pressure inside the chamber at or below the pressure of the second receiving space includes a step of discharging gas generated from the electrolyte and trapped in the second receiving space.

4. The method according to claim 3, wherein the step of maintaining the pressure inside the chamber at or below the pressure of the second receiving space is performed after the step of punching the through hole penetrating a portion of the second receiving space.

5. The method according to claim 4, further comprising:
a step of sealing the first receiving space by placing a sealing member between the first receiving space and the second receiving space,
wherein the step of sealing the first receiving space is performed after the step of maintaining the pressure inside the chamber at or below the pressure of the second receiving space.

6. The method according to claim 3, further comprising:
a step of maintaining the pressure inside the chamber at atmospheric pressure through the pump,
wherein the step of maintaining the pressure inside the chamber at atmospheric pressure through the pump is performed after the step of pressing at least the portion of the first receiving space through a pressurizing member that moves to contact at least the portion of the first receiving space and the step of fixing at least the portion of the case through the fixing member that moves to contact at least the portion of the periphery of the case.

7. The method according to claim 6, wherein the step of maintaining the pressure inside the chamber at atmospheric pressure through the pump is performed while the pressing member presses at least the portion of the first receiving space and the fixing member maintains a state of fixing at least the portion between the first receiving space and the second receiving space.

8. The method according to claim 1, further comprising:
a step of injecting the electrolyte into the first receiving space, and
a step of charging and discharging the electrode assembly through a lead tab portion electrically connected to the electrode assembly and protruding outward,
wherein the step of pressing at least the portion of the first receiving space is performed after the step of injecting the electrolyte and the step of charging the electrode assembly.

9. A battery manufacturing apparatus for manufacturing the battery cell, including an electrode assembly; an electrolyte in which the electrode assembly is immersed; a case including a first receiving space accommodating the electrode assembly and the electrolyte; and a second receiving space spaced apart from the first receiving space and communicating with the first receiving space, the apparatus comprising:
a chamber including a space in which the battery cell is accommodated;
a pump controlling the air inside the chamber to create a vacuum inside the chamber or to release the vacuum inside the chamber;
a pressing member contacting at least a portion of the first receiving space and pressing at least a portion of the first receiving space;
a fixing member contacting at least a portion of the periphery of the case and fixing at least a portion of the case; and
a punching member that moves toward the second receiving space and forms a through hole penetrating a portion of the second receiving space.

10. The apparatus according to claim 9, wherein the fixing member is arranged on a plane spaced apart from the first receiving space and the second receiving space by a predetermined interval.

11. The apparatus according to claim 10, wherein the fixing member is arranged adjacent to each end of the second receiving space.

12. The apparatus according to claim 10, wherein the fixing member has an inverted L-shape or a shape symmetrical to the inverted L-shape on a plane and surrounds at least a portion of the corners of the first receiving space adjacent to the second receiving space.

13. The apparatus according to claim 9, wherein the punching member punches the through hole while the pressing member presses the first receiving space and the fixing member fixes at least a portion of the case.

14. The apparatus according to claim 13, wherein the pump makes the pressure inside the chamber at or lower than the pressure of the second receiving space or maintains the pressure inside the chamber at atmospheric pressure while the pressing member presses the first receiving space and the fixing member fixes at least a portion between the first receiving space and the second receiving space.

15. The apparatus according to claim 9, further comprising:
a sealing member disposed between the first receiving space and the second receiving space and sealing the first receiving space.
